(19) United States
(12) Patent Application Publication
(10) Pub. No.: US 2010/0315421 A1
(43) Pub. Date: Dec. 16, 2010

(54) Generating fog effects in a simulated environment

(75) Inventors: Adam Ford, Burbank, CA (US); John Paul Ownby, Burbank, CA (US)

Correspondence Address: DISNEY ENTERPRISES, INC.;C/O KNOBBE, MARTENS, OLSON & BEAR, LLP, 2040 MAIN STREET, 14TH FLOOR, IRVINE, CA, 92614, US

(73) Assignee: Disney Enterprises, Inc., Burbank, CA (US)

(21) Appl. No.: 12/456,458

(22) Filed: Jun. 16, 2009

(51) Int. Cl. G06T 15/50

(52) U.S. Cl. 345/426

(57) ABSTRACT

A system and method for generating fog effects in a simulated environment. A fog color is selected using a the orientation of a virtual camera with respect to a three dimensional fog color map. Fog effects are generated based in part on the selected fog color.

### BACKGROUND

1. Field of the Invention

This application generally relates to computerized graphics.

2. Description of the Related Technology

The proliferation of computing devices within our society has greatly increased in the past years. Where computing devices such were previously uncommon, now, a large percentage of society has access to or owns at least one computing device. Along with the growth of computing devices, the recreational use of computing devices has grown as well. Gaming consoles such as the Microsoft XBOX, Sony Playstation, Sony PSP, Nintendo Wii, Nintendo DS, and personal computer systems are now common place in our society. The number of users who now have access to such devices has grown significantly and as a result, there has been an explosion in the development of new computer and console games. One aspect of gaming that has developed is the use of sophisticated processing to create simulated graphical environments for computer users. In order to improve the quality of simulated environments, it may be desirable to enhance the manner in which visual effects such as fog are generated in virtual environments.

### SUMMARY

In one embodiment, a method of simulating fog is provided. The method comprises selecting a color from a three dimensional fog color map based, at least in part, on an orientation of a virtual camera in a simulated environment with respect to the three dimensional fog color map. Further the method includes generating a fog effect for a pixel based, at least in part, on the color selected from the three dimensional fog color map. The three dimensional fog color map has a fixed orientation with respect to the simulated environment. A set of color properties associated with the three dimensional fog color map is determined based, at least in part, on an image generated by a person.

In another embodiment, an apparatus for simulating fog is provided. The apparatus has a memory configured to store a three dimensional fog color map and a processor coupled to the memory. The processor is configured to select a color from the three dimensional fog color map based, at least in part, on an orientation of a virtual camera in a simulated environment with respect to the three dimensional fog color map. The processor is further configured to generate a fog effect for a pixel based, at least in part, on the color selected from the three dimensional fog color map. In this embodiment, the three dimensional fog color map has a fixed orientation with respect to the simulated environment and a set of color properties associated with the three dimensional fog color map is determined based, at least in part, on an image generated by a person.

In one embodiment, an apparatus including a computer-readable medium is provided. The computer-readable medium has instructions stored thereon that, if executed by a computing device, cause the computing device to perform a method that comprises selecting a color from a three dimensional fog color map based, at least in part, on an orientation of a virtual camera in a simulated environment with respect to the three dimensional fog color map. The method also includes generating a fog effect for a pixel based, at least in part, on the color selected from the three dimensional fog color map. The three dimensional fog color map has a fixed orientation with respect to the simulated environment. The set of color properties associated with the three dimensional fog color map is determined based, at least in part, on an image generated by a person.

In one embodiment, an apparatus for simulating fog is provided. The apparatus comprises means for selecting a color from a three dimensional fog color map based, at least in part, on an orientation of a virtual camera in a simulated environment with respect to the three dimensional fog color map. The apparatus further includes means for generating a fog effect for a pixel based, at least in part, on the color selected from the three dimensional fog color map. The three dimensional fog color map has a fixed orientation with respect to the simulated environment. The set of color properties associated with the three dimensional fog color map is determined based, at least in part, on an image generated by a person.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram illustrating a computing system.

FIG. 2 is a functional block diagram of a computing device.

FIG. 3 is a diagram illustrating a simulated environment and an embodiment of a method of selecting a fog color.

FIG. 4 is a diagram illustrating a cube map.

FIG. 5 is an image generated using an embodiment of a method of selecting a fog color.

FIG. 6 is a diagram illustrating a simulated environment and another embodiment of a method of selecting a fog color.

FIG. 7 is a flow diagram of an embodiment of a method for selecting a fog color.

FIG. 8 is a flow diagram of an embodiment of a method for generating a fog effect.

FIG. 9 is a flow diagram of another embodiment of a method for selecting a fog color.

### DETAILED DESCRIPTION OF CERTAIN EMBODIMENTS

The following detailed description presents various descriptions of specific embodiments. However, the invention can be embodied in a multitude of different ways as defined and covered by the claims. In this description, reference is made to the drawings wherein like parts are designated with like numerals throughout.

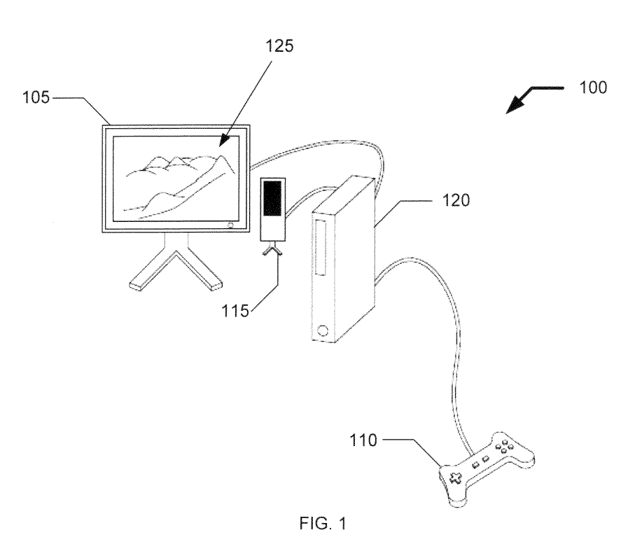

FIG. 1 is a diagram of a computing system 100. Computing system 100 comprises a display 105, an input device 110, speaker 115 and computing device 120. Display 105 may be an LCD monitor, a CRT monitor, a plasma monitor, a touch screen monitor, a projection screen or other display type. Input device 110 may be a game console controller or other type of input device such as a keyboard, mouse, motion sensitive controller, touch pad, or touch screen. Computing device 120 may be a dedicated gaming console or other more general purpose computing device.

Computing system 100 is used, in one embodiment, to facilitate playing a video game. In this embodiment, computing device 120 may be configured to generate a simulated environment and to present the simulated environment to a user via output devices such as display 105 and speaker 115. For example, computing device may be configured to generate an image 125 depicting a portion of the simulated environment. Computing device 120 is further configured to receive input from a user via input device 110. Computing device 120 determines the effect of this input on the simulated environment and outputs the updated environment to the user via the output devices.

To enhance the sense of reality in the simulated environment, computing device 120 may be configured to incorporate details such as fog into the simulated environment. The inclusion of fog can enhance the perception of reality in a simulated environment. Further, the ability to manipulate fog appearance in aspects such as color and shaping can enhance the ability of designers to create a compelling and engrossing environment. While the term fog is used, it will be appreciated by one of ordinary skill in the art that the present systems and methods may be employed to generate a broad array of visual effects in simulated environments. For example, the present systems and methods encompass the generation of smoke, clouds, haze, smog, atmospheric effects, and other visual effects.

As described in greater detail below, significant improvement in fog effect generation may be obtained by choosing fog color based on orientation of a virtual camera with respect to a virtual environment. In particular, a fog color map having a particular orientation may be used to select a fog color based on the orientations of the virtual camera or simulated environment. This manner of choosing a color for fog is advantageous because it is computationally efficient. For example, the fog color map may be implemented as a cube map having a certain orientation with respect to the simulated environment. Cube maps can be quickly and efficiently processed to select fog colors for generating engaging effects with minimal computational resources. Further, this manner of choosing fog color is advantageous because it provides an enhanced ability to control the precise visual characteristics of fog effects to maximize artistic expression of environment designers.

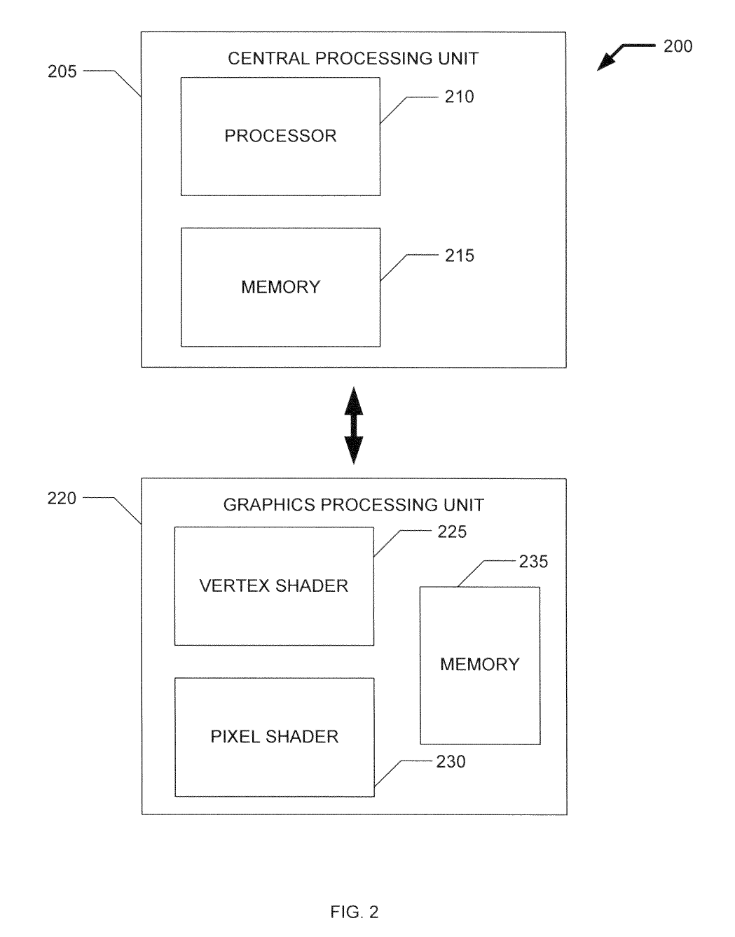

FIG. 2 is a functional block diagram of a computing device 200. In one embodiment, computing device 200 is similar to computing device 120 of FIG. 1. In particular, computing device 200 may be configured to generate images depicting a simulated environment such as image 125. In one embodiment, the computing device 200 may be configured to generate fog effects as described herein. The computing device 200 comprises a central processing unit (CPU) 205. The CPU 205 further comprises a processor 210 coupled to a memory 215. The processor 210 may be configured to process data related to a simulated environment. For example, the processor 210 may be configured to track position and orientation information of a virtual camera within a virtual environment. The processor 210 may be further configured to receive input from peripheral devices such as the input device 110 and to determine the effect of the input on the virtual camera and the simulated environment. The processor 210 may be further configured to store information to and retrieve information from the memory 215. For example, the memory 215 may store information related to a simulated environment such as position and orientation information. This information may be read into or written from the processor 210 as needed.

In one embodiment, the CPU 205 may also be coupled or connected to a graphics processing unit (GPU) 220. The GPU 220 may be configured to generate images representing a simulated environment which can then be displayed to a user. In one embodiment, the CPU 205 may transmit information to GPU 220 in order to facilitate image generation. For example, this information may comprise positional or orientation information of the virtual camera in addition to other information. The GPU 220 may be configured to use information passed from the CPU 205 to generate images depicting the simulated environment to a user. The GPU 220 comprises a vertex shader 225. The vertex shader 225 may be configured to convert the various features of the simulated environment into a form or representation suitable for use in generating an image to display to the user. For example, the vertex shader 225 may turn information regarding the shape and position of features such as buildings or hills into a plurality of vertices representing surfaces which may be visible to the virtual camera. The vertex shader 225 may also be configured to write to and read from memory 235. For example, the memory 235 may contain positional and model information for features in the simulated environment. This information may be stored in the memory 235 until accessed as needed by the vertex shader 225. The vertex shader 225 may also be configured to transmit information to a pixel shader 230. The pixel shader 230 may be configured to generate color values for pixels to be seen by the user. For example, the pixel shader 230 may configured to receive information about visible surfaces from vertex shader 225 and to use this surface information to generate color values for the visible pixels based on the surface information and additional information such as texture, lighting, or reflection information. The vertex shader 225 and the pixel shader 230 may both be configured to read from and write to the memory 235. For example, the vertex information passing from the vertex shader 225 to the pixel shader 230 may be stored or buffered in the memory 235 before it is accessed by the pixel shader 230.

In one embodiment, the interoperation of CPU 205 and GPU 220 is thus capable of generating color values for the pixels which compose an image depicting a portion of the simulated environment. As discussed previously, it may be desirable to enhance the generated image by adding a fog effect to the image. In one embodiment, this fog effect may be generated by performing additional processing at GPU 220 or CPU 205. For example, a fog effect may be generated according to equation 1 below:

PVe=f*PVi+(1−f)FV Equation (1)

Where:

PVe=a final or end pixel value for a given pixel, the pixel value corresponding to a particular color;

f=a weighting factor for determining the mixture of an intermediate pixel value and a fog value;

PVi=an intermediate pixel value; and

FV=a fog color value.

In one embodiment, equation 1 may be used to generate a fog effect based on the distance between the virtual camera and the surface represented in a particular pixel. For example, the variable f may change as a function of the distance from the virtual camera to the surface represented by the pixel. In one embodiment, f may increase linearly as the distance between virtual camera and an observed surface increases. In other embodiments, f may increase exponentially or according to another mathematical relationship. In this example, as f increases with relative distance, the contribution of the fog color value to a final pixel value increases while the contribution of the intermediate pixel value to the final pixel value decreases. The result is that surfaces positioned far away from the virtual camera appear to have a large amount of fog obscuring the surface. This method of generating fog effects may provide a sense of depth and realism in a simulated environment.

Advantageously, fog effect generation may be further enhanced by selecting different fog color values for different pixels or different groups of pixels. In this embodiment, in addition to changing the intensity of fog based on distance, the color of the fog for each pixel may be controlled. As discussed in detail below, by controlling the color of fog contributing to final pixel values, a simulated environment designer can create realistic looking effects such as patchy or settling fog without expensive calculations associated with ray tracing or light diffusion analysis. Further, a designer can choose to create fog effects that, though perhaps unrealistic, can enhance the cinematic experience of a user. This embodiment comprising controlling fog color will be better understood by reference to the following figures and accompanying description.

The processor 210 may comprise any general purpose single or multi-chip microprocessor such as an ARM, Pentium®, Pentium II®, Pentium III®, Pentium IV®, Pentium® Pro, an 8051, a MIPS®, a Power PC®, an ALPHA®, an application specific integrated circuit (ASIC), or any special purpose microprocessor such as a digital signal processor, microcontroller, or a programmable gate array. Further, the functionality of processor 210, memory 215, 235, vertex shader 225, and pixel shader 230 may all be implemented in a single chip or as two or more discrete components. Further the functionality of vertex shader 225 and pixel shader 230 may be performed by one or more software modules executing on processor 210.

Memory 215, 235 may comprise a hard disk, RAM, ROM, a memory card, CD-ROM, DVD-ROM, or some other means for storing data. Memory 215, 235 may also comprise computer readable medium having written thereon instructions for carrying out the processes described herein.

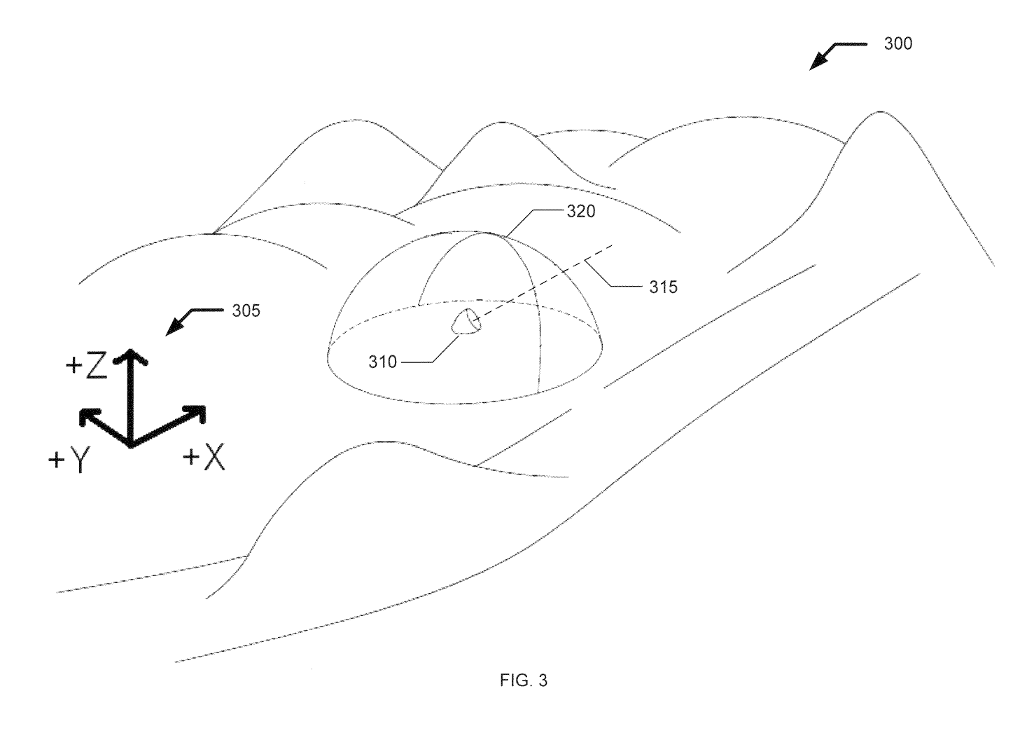

FIG. 3 is a diagram illustrating a simulated environment 300 and an embodiment of a method of selecting a fog color. In one embodiment, the simulated environment 300 is described in relation to a set of axes 305. For example, the simulated environment 300 may be defined by reference to a set of mutually orthogonal axes X, Y and Z. Positioned within the simulated environment 300 is a virtual camera 310. In one embodiment, virtual camera 310 represents the viewpoint of a user within the simulated environment 300. The position and orientation of the virtual camera 310 within the simulated environment 300 may also be defined by reference to the axes 305. For example, in the present illustration, the orientation of view 315 of virtual camera 310 may be aligned primarily along the positive X axis of the axes 305. Further, the virtual camera 310 may be positioned at location in the simulated environment 300 corresponding to a position (X1, Y1, Z1).

As described above, computing system 200 may be configured to generate an image based upon the view 315 of the virtual camera 310 within the simulated environment 300. In addition, system 200 may be configured to generate a fog effect to enhance the generated image. In one embodiment, to facilitate control of fog color selection, a three dimensional fog color map 320 is provided. The three dimensional fog color 320 map may also be referred to as a fog color map. In one embodiment, a three dimensional fog color map 320 comprises a data structure which contains one or more color values. The color values may be expressed as tuples of red, green, and blue (RGB) values. In other embodiments, the color values may be represented as other forms of color information. In one embodiment the three dimensional fog color map 320 may be represented as a single or multidimensional array of color values. The individual color values may also be referred to as pixels in the three dimensional color map 320. In one embodiment, each color value corresponds to a different orientation with respect to the simulated environment 300 or axes 305. In some embodiments, three dimensional fog color map 320 may be described as having a particular shape. The associated shape may be indicative of the manner in which the color values are arranged. Further, the associated shape may relate to the manner in which pixels from a generated image are matched or paired with color values from the three dimensional fog color map 320. For example, a generated image may comprise a fixed number of pixels which are arranged as a plurality of rows and columns. When generating the fog effect, system 200 may need to match or pair color values from the three dimensional fog color map 320 with the pixels in the image to be generated to generate a fog effect. The association of particular color values from the fog color map with particular pixels from the generated image may depend on the manner in which the particular fog color map is organized. Further, a fog color map may not define color value for all orientations. For example, color value may not be defined for orientations corresponding to the direction directly beneath the camera. The lack of color value definitions may also correspond to the association of a particular shape for a three dimensional fog color map 320. Alternatively, a fog color map which defines color values for all or most orientations may be described as encapsulating the virtual camera. Thus, in one embodiment, three dimensional fog map 320 comprises a hemisphere.

In one embodiment, three dimensional fog color map 320, unlike the virtual camera 310, may have a fixed orientation with respect to the simulated environment 300 and axes 305. Thus the generated image may express varying fog effects as the relative orientation of the virtual camera 310 to the fog color map changes 320. For example, the color values of the three dimensional fog color map 320 oriented roughly in the positive X direction may be indicative of brown, oozing fog. In the same example, the color values of the three dimensional fog color map 320 oriented roughly in the positive Y direction may be indicative of grey billowing fog. If the camera were initially oriented in roughly the positive X direction, the pairing of color values from the from the fog color map with pixels in the generated image based on orientation may result in the generation of fog effects in the generated image of brown, oozing fog. However, as the virtual camera pans from an orientation in the positive X direction to the positive Y direction, the paring of colors with the pixels in the image will result in the generation of billowing grey fog effects.

As described above, the three dimensional fog color map 320 may define different fog colors according to variations in orientation. For example, the three dimensional fog color map 320 may comprise a number of pixels proportional or related to the number of pixels in the generated image such that each pixel in the generated image is associated with a corresponding pixel from the three dimensional fog color map 320. Thus, each pixel in a generated image may be associated with a distinct fog color value from the three dimensional fog color map 320. In another embodiment, the granularity of the fog color definition in the three dimensional fog color map 320 may be scaled according to design considerations to increase or decrease the ratio of pixels in the three dimensional fog color map 320 to pixels in the generated image.

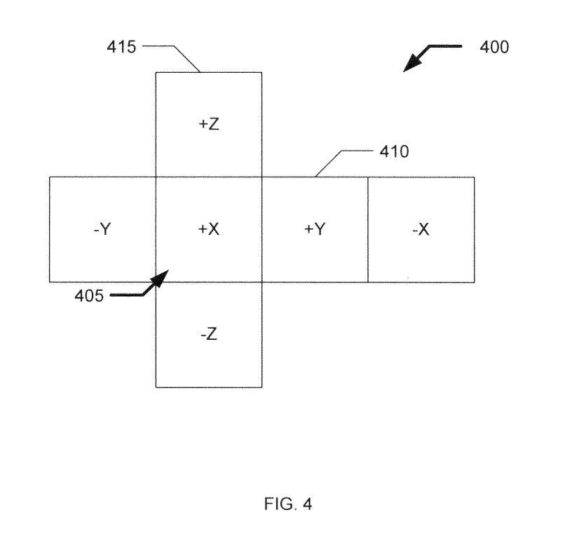

FIG. 4 is a diagram illustrating a cube map. As described above with respect to FIG. 3, a three dimensional fog color map may comprise a hemisphere. Alternatively, the three dimensional fog color map may comprise additional shapes such as a sphere, column, rectangular prism, or polyhedron. In addition, in one embodiment a three dimensional fog color map may be implemented as a cube map. FIG. 4 illustrates an unfolded cube map 400. For convenience, each surface of cube map 400 has been labeled in relation to an axis of axes 305. In one embodiment, cube map 400 is oriented with surface 405 directed in the positive X direction, surface 410 directed in the positive Y direction, and surface 415 directed in the positive Z direction. In one embodiment, each surface comprises color values associated with a particular desired fog effect. Thus as described above, if the virtual camera were to pan from the positive X direction to the positive Y direction, the fog effect generated by system 200 would transition from the effect derived from surface 405 to the effect derived from 410. It will be appreciated that the edge between the two surfaces may be processed using one or more techniques to smooth the transition between the fog effects derived from the various surfaces. For example, blending or averaging across surfaces at the edges may be employed. In another embodiment, the entire cube map 400 may be assigned fog color values representative of a single continuous fog effect. In such an embodiment, the need or use of blending may be substantially decreased.

The use of cube map 400 is particularly advantageous because each surface may be represented in one or more data structures that are easily processed by computing device 200. Further, the use of fog color maps such as cube map 400 allow simulated environment designers to mimic realistic looking fog effects without extensive processing power. In addition, the fog color maps allow designers to customize fog appearance for artistic effect. For example, an artist can generate an image using software, by hand, or by photograph. The image can then be applied to a cube map to generate a fog effect as described herein.

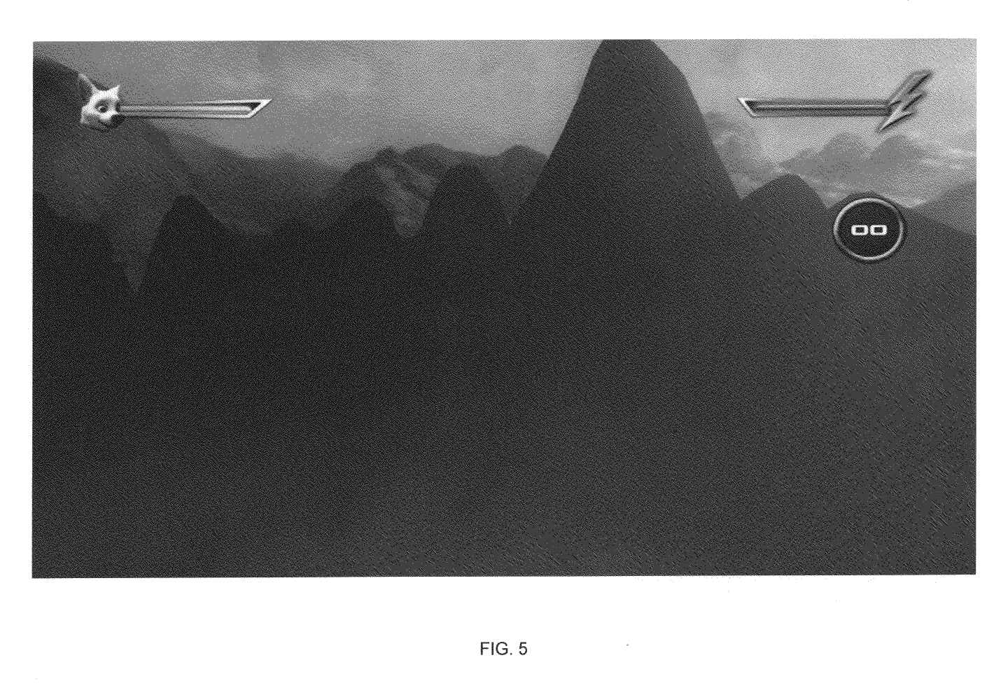

FIG. 5 is an image generated using an embodiment of a method of selecting a fog color. FIG. 5 is an image taken from the BOLT video game with certain foreground objects removed from view. As seen in FIG. 5, a band of patchy fog occupies the lower left portion of the screen. Towards the right side of the screen the fog thickens and begins to extend upwards towards the top right portion of the screen and becomes wispier. Advantageously, this artistic effect enhances the quality of the scene with minimal computational expense because of the efficiency of the cube map implementation.

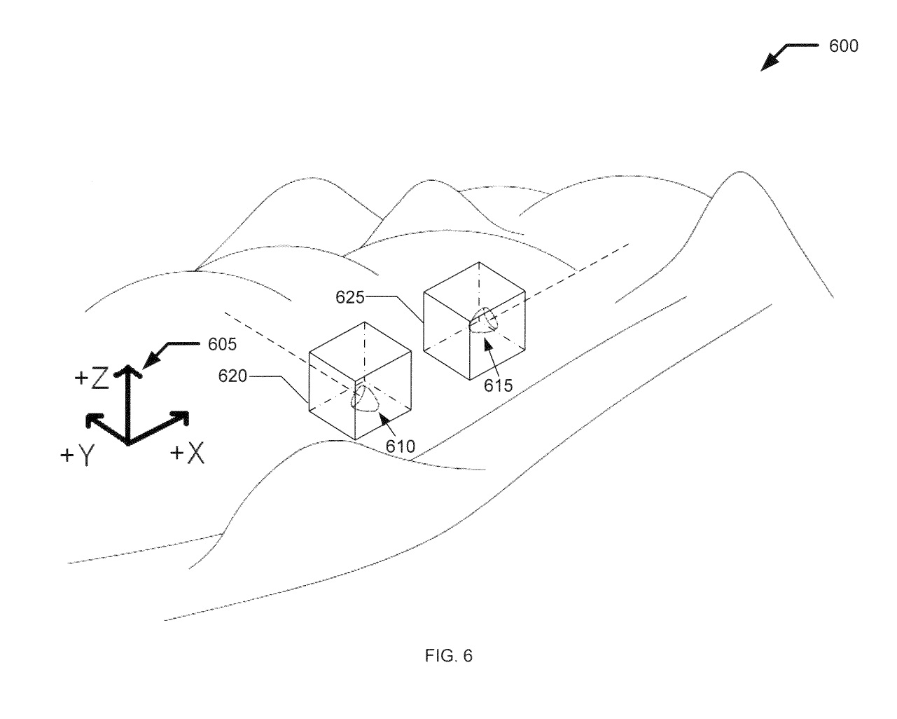

FIG. 6 is a diagram illustrating a simulated environment 600 and another embodiment of a method of selecting a fog color. Simulated environment 600 may be defined relative to axes 605. The positions and orientations of virtual cameras 610 and 615 may also be defined relative to the axes 605. As discussed above the system 200 may be configured to generate images based upon the perspective of the virtual cameras 610 and 615. Further, system 200 may be configured to generate fog effects for the generated images. In one embodiment, the system 200 is configured to store multiple sets of fog color values corresponding to different cube maps. Further, in response to certain stimuli, the fog color values of a three dimensional fog color map may be changed. For example, some simulated environments are designed to simulate changes in weather. At one point in time, the weather may be relatively clear and minimal fog effects may be generated. However, as time passes the weather may change and it may be desirable to generate heavier fog effects to simulate changing conditions. The system 200 may be configured to store a plurality of cube maps and select a cube map for use based on conditions in the simulated environment. For example, the particular cube map used may depend on time, planned events, random events, user input, or other stimuli. In another embodiment, fog color values may be changed in response to a change in position of the virtual camera. For example, at a first location within a simulated cave, it may be desirable to generate a first fog effect based on a first cube map. However, as the virtual camera leaves the cave and enters a forest, it may be desirable to generate a second fog effect based on a second cube map. The system 200 may be configured to store a plurality of cube maps and to select a particular cube map for used based on the position of the virtual camera within a simulated environment. For example, the cube map 620 may have a first set of fog color values based at least in part on the position of the virtual camera 610. Further, the cube map 625 may have a second set of fog color values based at least in part on the position of virtual camera 615. In another embodiment, system 200 may be configured to store a plurality of cube maps and to use them sequentially to effectuate an animation effect. For example, by sequentially loading different cube maps in different frames, the system 200 could simulate a moving fog effect.

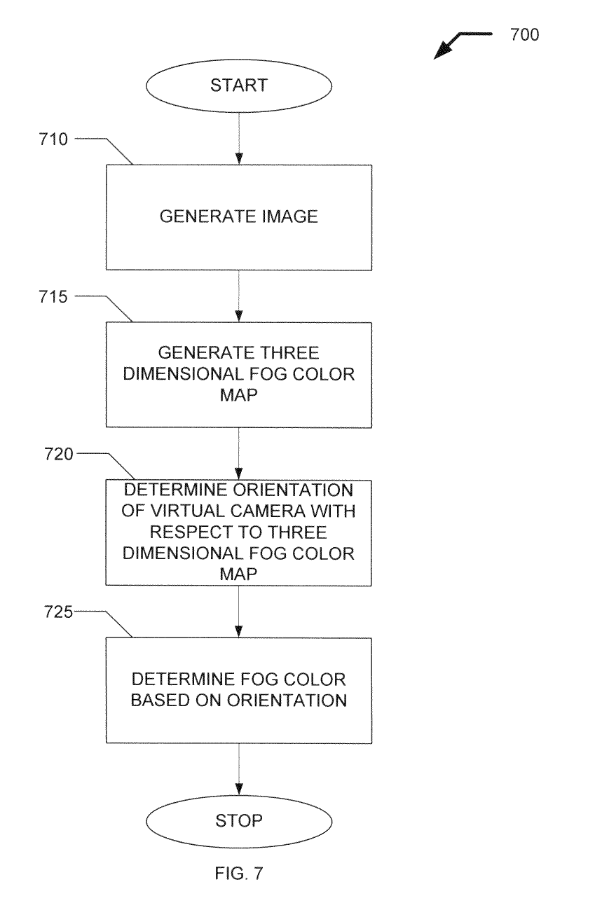

FIG. 7 is a flow diagram of an embodiment of a method 700 for selecting a fog color. At step 710 of the method, an image is generated. As discussed above, the image being generated may be generated by any suitable means such as with writing utensils, with computer assistance, or with a camera. At step 715, a three dimensional fog color map is generated based on the generated image. For example an image generated by a person could be applied to the three dimensional fog color map. In the case of a cube map, this may comprise dividing the image into six pieces and associating a piece with each face. In the case of a sphere or other shape, this may comprise a transformation mapping the image into the appropriate form. At step 720 the orientation of a virtual camera with respect to the three dimensional fog color map is determined. As mentioned above with respect to FIG. 3, the three dimensional fog color map may have a fixed orientation with respect to the simulated environment. Thus, determining the orientation of the virtual camera with respect to the color map may comprise determining the orientation of the virtual camera with respect to the environment. The orientation of the virtual camera may be determined directly by the system 200 or the orientation may be tracked and stored in memory to facilitate look up when necessary. Alternatively, an indication of the orientation may be supplied to the system 200 via an external input.

At step 725 a fog color is selected from the three dimensional fog color map based on the orientation. For example, a first pixel in an image to be generated may have an orientation expressed as a vector or other format. The system 200 may determine a pixel in the three dimensional fog color map having the same orientation. In one embodiment, this process of determining a corresponding fog color may be repeated for each pixel or for groups of pixels until a fog color has been selected for each pixel in the image to be generated.

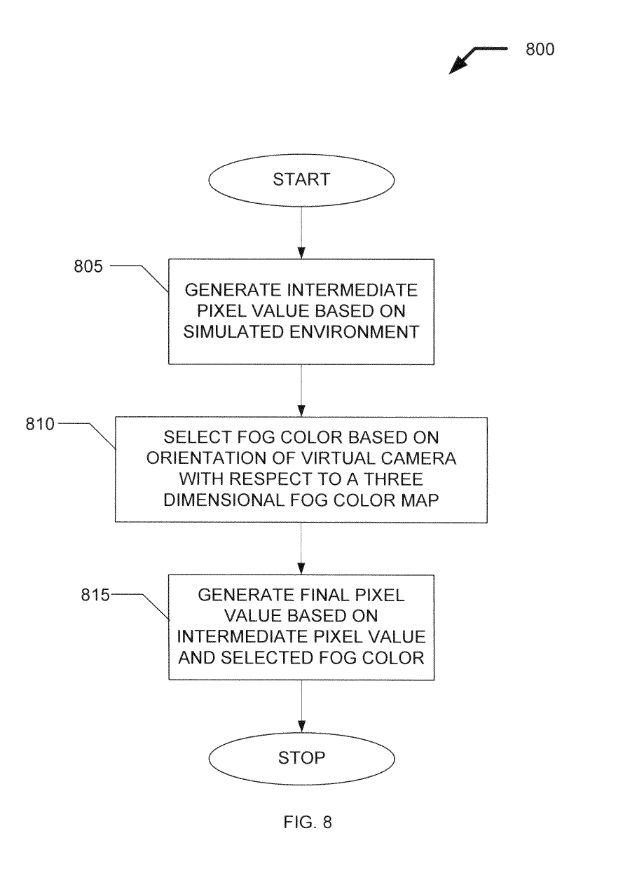

FIG. 8 is a flow diagram of an embodiment of a method 800 for generating a fog effect. At step 805 of the method, an intermediate pixel value based on the simulated environment is generated. The intermediate pixel value may incorporate a contribution from diffuse light, diffuse color, specular light, or specular color. The system 200 may generate the intermediate value. Further, the intermediate pixel value may correspond to a pixel in an image to be generated for display to a user. At step 810, a fog color is selected based on the orientation of the virtual camera with respect to a three dimensional fog color map. As discussed above with respect to method 700, the pixel having the intermediate value may have an orientation expressed as a vector or other format. The system 200 may determine a pixel in the three dimensional fog color map having the same orientation. The system 200 may then select the color value from the corresponding pixel in the three dimensional fog color map. At step 815, a final pixel value is generated based on the intermediate pixel value and the selected fog color. As discussed above with respect to equation (1), the intermediate value and the fog color may be combined according to a weighting based on the distance from the virtual camera to the surface represented by the pixel. This combination or blend of the intermediate pixel value and fog color may be the final pixel value.

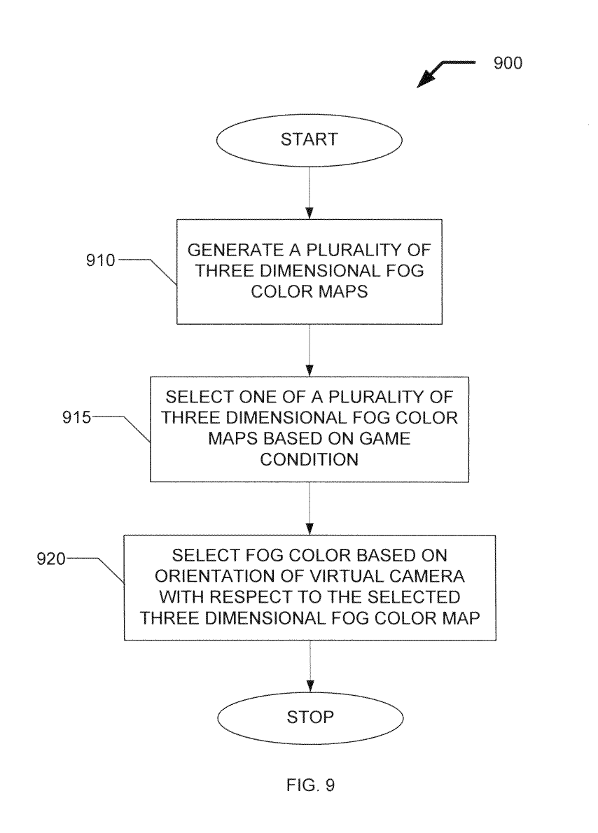

FIG. 9 is a flow diagram of another embodiment of a method 900 for selecting a fog color. At step 910, a plurality of three dimensional fog color maps are generated. As discussed above with respect to method 700, generating the plurality of three dimensional fog color maps may comprise generating a plurality of images and then converting the images into fog color maps. At step 915, one of the plurality of three dimensional fog color maps is selected based on game condition. As discussed above with respect to FIG. 6, system 200 may select a fog color map based on simulated weather condition, time, position, planned or random events, user input, or other stimuli. At step 920, a fog color is selected based on the orientation of the virtual camera with respect to the selected three dimensional fog color map. The above-described methods may be realized in a program format to be stored on a computer readable recording medium that includes any kinds of recording devices for storing computer readable data, for example, a CD-ROM, a DVD, a magnetic tape, memory card, and a disk, and may also be realized in a carrier wave format (e.g., Internet transmission or Bluetooth transmission).

While specific blocks, sections, devices, functions and modules may have been set forth above, a skilled technologist will realize that there are many ways to partition the system, and that there are many parts, components, modules or functions that may be substituted for those listed above.

While the above detailed description has shown, described, and pointed out the fundamental novel features of the invention as applied to various embodiments, it will be understood that various omissions and substitutions and changes in the form and details of the system illustrated may be made by those skilled in the art, without departing from the intent of the invention.

What is claimed is:

1. A method of simulating fog, the method comprising:
selecting a color from a three dimensional fog color map based, at least in part, on an orientation of a virtual camera in a simulated environment with respect to the three dimensional fog color map; and
generating a fog effect for a pixel based, at least in part, on the color selected from the three dimensional fog color map;
wherein the three dimensional fog color map has a fixed orientation with respect to the simulated environment and a set of color properties associated with the three dimensional fog color map is determined based, at least in part, on an image generated by a person.

2. The method of claim 1, further comprising determining the orientation of the virtual camera with respect to the three dimensional fog color map.

3. The method of claim 1, further comprising receiving an indication of the orientation of the virtual camera with respect to the three dimensional fog color map.

4. The method of claim 1, wherein the three dimensional fog color map is a cube map.

5. The method of claim 1, wherein generating the fog effect further comprises:
determining a first value for the pixel; and
determining a second value for the pixel based, at least in part, on the first value for the pixel and the color selected from the three dimensional fog color map.

6. The method of claim 5, wherein determining the first second value for the pixel comprises combining a weighted proportion of the first value for the pixel and the selected color.

7. The method of claim 1, wherein the three dimensional fog color map encapsulates the virtual camera.

8. The method of claim 1, wherein the set of color properties associated with the three dimensional fog color map is determined based, at least in part, on a position of the virtual camera within the simulated environment.

9. The method of claim 1, wherein the set of color properties associated with the three dimensional fog color map changes with time.

10. The method of claim 1, wherein the set of color properties associated with the three dimensional fog color map changes based at least in part on input from a user.

11. The method of claim 1, wherein the pixel is one of a plurality of pixels in a video frame.

12. An apparatus for simulating fog, the apparatus comprising:
a memory configured to store a three dimensional fog color map; and
a processor coupled to the memory, wherein the processor is configured to:
select a color from the three dimensional fog color map based, at least in part, on an orientation of a virtual camera in a simulated environment with respect to the three dimensional fog color map; and
generate a fog effect for a pixel based, at least in part, on the color selected from the three dimensional fog color map;
wherein the three dimensional fog color map has a fixed orientation with respect to the simulated environment and a set of color properties associated with the three dimensional fog color map is determined based, at least in part, on an image generated by a person.

13. The apparatus of claim 12, wherein the processor is further configured to determine the orientation of the virtual camera with respect to the three dimensional fog color map.

14. The apparatus of claim 12, wherein the processor is configured to receive an indication of the orientation of the virtual camera with respect to the three dimensional fog color map.

15. The apparatus of claim 12, wherein the three dimensional fog color map is a cube map.

16. The apparatus of claim 12, wherein the memory is configured to store one or more additional one or more additional three dimensional fog color maps.

17. The apparatus of claim 16, wherein the processor is configured to select the three dimensional fog color map or one of the one or more three dimensional fog color maps based, at least in part on the position of the virtual camera in the simulated environment.

18. The apparatus of claim 12, wherein the pixel is one of a plurality of pixels in a video frame.

19. An apparatus including a computer-readable medium having instructions stored thereon that, if executed by a computing device, cause the computing device to perform a method comprising:
selecting a color from a three dimensional fog color map based, at least in part, on an orientation of a virtual camera in a simulated environment with respect to the three dimensional fog color map; and
generating a fog effect for a pixel based, at least in part, on the color selected from the three dimensional fog color map;
wherein the three dimensional fog color map has a fixed orientation with respect to the simulated environment and a set of color properties associated with the three dimensional fog color map is determined based, at least in part, on an image generated by a person.

20. An apparatus for simulating fog, the apparatus comprising:
means for selecting a color from a three dimensional fog color map based, at least in part, on an orientation of a virtual camera in a simulated environment with respect to the three dimensional fog color map; and
means for generating a fog effect for a pixel based, at least in part, on the color selected from the three dimensional fog color map;
wherein the three dimensional fog color map has a fixed orientation with respect to the simulated environment and a set of color properties associated with the three dimensional fog color map is determined based, at least in part, on an image generated by a person.
